(19) United States
(12) Patent Application Publication
(10) Pub. No.: US 2011/0024065 A1
(43) Pub. Date: Feb. 3, 2011

(54) Window Covering

(75) Inventor: Tzong Fu Lin, Taipei (TW)

Correspondence Address: BUCHANAN INGERSOLL & ROONEY PC, P.O. BOX 1404, ALEXANDRIA, VA, 22313-1404, US

(73) Assignee: Whole Space Industries LTD, Taipei (TW)

(21) Appl. No.: 12/511,213

(22) Filed: Jul. 29, 2009

(51) Int. Cl. E06B 9/24

(52) U.S. Cl. 160/340

(57) ABSTRACT

A window covering is provided that includes a first rail and window covering material positioned adjacent to the first rail. One or more telescoping tubes are attached to the headrail and extend to the window covering material or to a bottom rail. The one or more telescoping tubes retract when the window covering material is retracted and extend when the window covering material is extended. Some embodiments of the window covering may include one or more lift cords. Portions of the one or more lift cords may extend from a lift mechanism through the telescoping tubes.

### FIELD OF INVENTION

The present invention relates to window coverings.

### BACKGROUND OF THE INVENTION

Blinds often utilize lift cords that extend from a headrail to window covering material such as slats, a fabric panel, or pleated material. On occasion, children have been able to become entangled in one of the lift cords of the blind. If the lift cord is around the child's neck and the child falls, the cord could act as a noose and strangle the child.

Indeed, reports of such incidents have prompted a major retailer to issue a recall of one product line of Roman shades and the United States Consumer Product Safety Commission has issued a warning about the danger of child entanglement and hanging from the cords in Roman shades. There have also been incidents of child entanglements in lift cords of venetian blinds and other types of window coverings.

As a result, the art has developed various types of child safety devices that are intended to prevent deaths of children who become entangled in lift cords. For instance, U.S. Pat. Nos. 7,261,138, 7,225,850, 7,117,918, 7,086,446, 7,000,672, 6,948,546, 6,918,425, 6,860,312, 6,637,493, 6,484,787, 5,630,458, 5,533,559 and 4,909,298 disclose child safety devices for blinds. Child safety devices may be configured to keep the lift cords taught so that the cords cannot be pulled away from the window covering material and form a noose or release the cord from the shade when a child becomes entangled in the shade.

Many conventional child safety devices for blinds are visible from the front of the shade and detract from the aesthetic effect of the shade. Further, such safety devices typically leave lift cords exposed such that the cords may still be grasped or pulled by a child.

A new device is needed for blinds that may prevent children from becoming entangled in lift cords. Preferably, such a device can prevent lift cords from being grasped or pulled by a child. Moreover, such a device preferably does not detract from the aesthetic effect provided by the blind.

### SUMMARY OF THE INVENTION

A window covering is provided that includes a first rail, one or more telescoping tubes and window covering material. The window covering material is positioned adjacent to the first rail and is moveable from a retracted position to an extended position. The one or more telescoping tubes extend from the first rail to a position adjacent to the lower portion of the window covering material. Opposite ends of the one or more telescoping tubes are attached to the first rail and the window covering material.

It should be understood that an end of a telescoping tube may be attached to window covering material by being attached to a lower rail or bottom rail that is attached to the window covering material. For instance, a ballast bar enclosed within a pocket defined in the window covering material may be attached to a telescoping tube to attach the telescoping tube to the window covering material. As another example, a bottom rail that is positioned below the window covering material and is attached to the window covering material may be attached to a telescoping tube to attach the telescoping tube to the window covering material. Of course, a telescoping tube may also be attached to window covering material by being directly attached to the window covering material.

Each telescoping tube may be generally cylindrical in shape or may be generally polygonal in shape. For example, a telescoping tube may be cylindrical in shape. As another example, a telescoping tube may be generally rectangular in shape.

Embodiments of my window covering may include a second rail attached to the window covering material adjacent to the lower portion of the window covering material. A top portion of each telescoping tube is attached to the first rail and a bottom portion of each telescoping tube is attached to the second rail. The second rail may be a rail that is lower than the first rail or may be a rail that is positioned above the first rail.

Some embodiments of my window covering include a lift mechanism attached to the first rail and also include a plurality of lift cords attached to the lift mechanism. The lift cords extend from the first rail to the window covering material. Each lift cord preferably extends through a respective telescoping tube. The first rail may also have a plurality of holes and respective lift cords may pass through respective holes and into respective telescoping tubes. Preferably, the lift mechanism includes one or more spring motors or one or more cord locks.

Other embodiments of my window covering can include a lift mechanism attached to the first rail, a lift cord attached to the lift mechanism and first and second telescoping tubes that extend from the first rail. The lift cord extends from the first rail to the window covering material. A first portion of the lift cord extends through the first telescoping tube and a second portion of the lift cord extends through the second telescoping tube. The first and second portions of the lift cord may be end portions that include a terminal end attached to a bottom rail or the lower portion of the window covering material. A middle portion of the lift cord may be attached to the lift mechanism. Preferably, the lift mechanism is a spring motor and the telescoping tubes and first rail enclose most, if not the entirety, of the lift cords.

It should be understood that the window covering material may be composed of numerous different materials. For instance, the window covering material may be composed of bamboo, woven wood, fabric, woven grass, or a film. For example, the window covering may be a shade composed of interconnected fabric segments. The fabric may be woven or non-woven fabric. As another example, the window covering material may be composed of interconnected woven wood or woven grass segments.

Some embodiments of my window covering may position the one or more telescoping tubes at least partially within the window covering material. For instance, telescoping tubes may be positioned within cellular material of a cellular shade. As another example, the telescoping tubes may extend through the pleated material of a pleated shade.

Each of the one or more telescoping tubes may include a plurality of telescoping tube portions that are each moveable relative to at least one other tube portion. For example, the tube portions may be configured have progressively smaller or larger diameters such that each smaller tube portion fits and moves within a tube portion having the next larger diameter. The telescoping tube portions may be generally cylindrical or generally polygonal in shape.

The one or more telescoping tubes are preferably composed of metal or plastic. Preferably, the material of the telescoping tubes is colored to provide a desired aesthetic effect that compliments or enhances the aesthetic effect of the window covering material. For example, the telescoping tubes may be composed of an opaque material or may be colored such that each telescoping tube contrasts with the color of the window covering material. As another example, the telescoping tubes may be clear or substantially transparent such that the telescoping tubes are relatively difficult to see such that they may minimally detract from the aesthetic effect provided by the window covering material. As yet another example, the one or more telescoping tubes may be colored to be the same color as the window covering material.

Embodiments of my window covering may also include a headrail, a bottom rail, window covering material positioned adjacent to the headrail, and a plurality of telescoping tubes. The window covering material is moveable from an extended position to a retracted position. Each telescoping tube has a first end attached to the headrail and a second end opposite the first end attached to the bottom rail. Each telescoping tube is configured to retract when the window covering material is moved to the retracted position and is configured to extend when the window covering material is moved to the extended position.

In some embodiments of my window covering, the bottom rail may be a bottommost ballast bar or rod located within a pocket defined in the window covering material. In other embodiments of my window covering, the bottom rail may be a rail, bar or rod attached to the bottommost edge of the window covering material. Preferably, the telescoping tubes are positioned along the rear face of the window covering such that the telescoping tubes are positioned adjacent to a window when the window covering is mounted.

It is contemplated that embodiments of my window covering may include telescoping tubes configured for use in Roman shades, pleated shades, venetian b blinds, cellular shades or other blinds. Some embodiments of my window coverings may also be top down/bottom up shades. It is also contemplated that embodiments of my window covering may include telescoping tubes that are configured for use in roll-up shades. For instance, the telescoping tubes may be generally U-shaped.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of my window covering and methods of making and using the same are shown in the accompanying drawings in which:

FIG. 1 is a front perspective view of a first present preferred embodiment of my window covering illustrating the window covering material in an extended position.

FIG. 2 is a rear perspective view of the first present preferred embodiment showing the window covering material in an extended position.

FIG. 3 is a view similar to FIG. 2 of the first present preferred embodiment illustrating the window covering material in a retracted position.

FIG. 4 is a top view of the headrail of the first present preferred embodiment, which shows the lift mechanism attached to the headrail.

FIG. 5 is a perspective view of a second present preferred embodiment of my window covering illustrating telescoping tubes positioned within the window covering material in dotted line.

FIG. 6 is a fragmentary view of the lift mechanism within the headrail of the second present preferred embodiment.

FIG. 7 is a perspective view of a third present preferred embodiment of my window covering.

### DETAILED DESCRIPTION OF PRESENT PREFERRED EMBODIMENTS

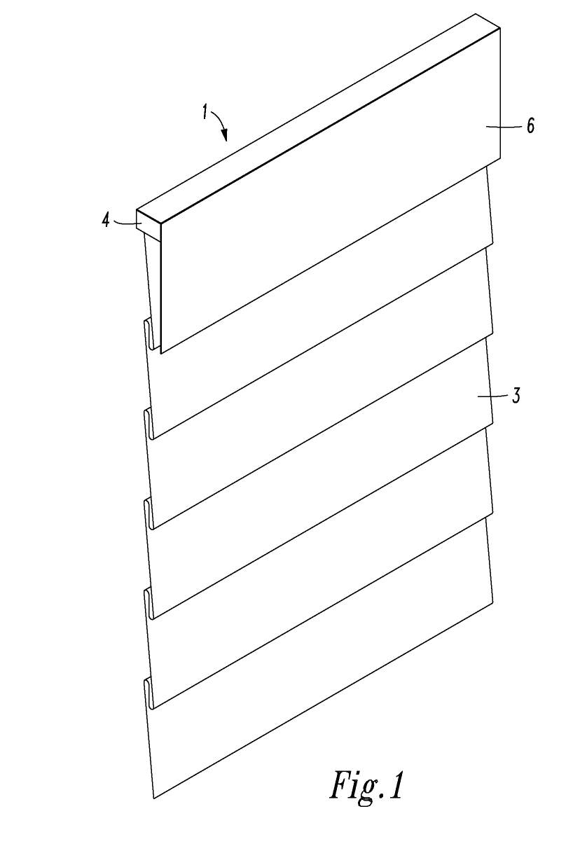

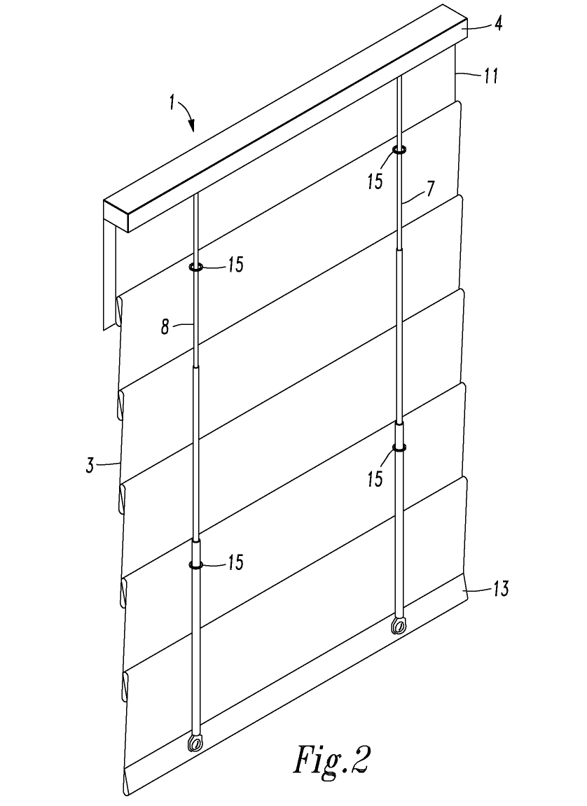

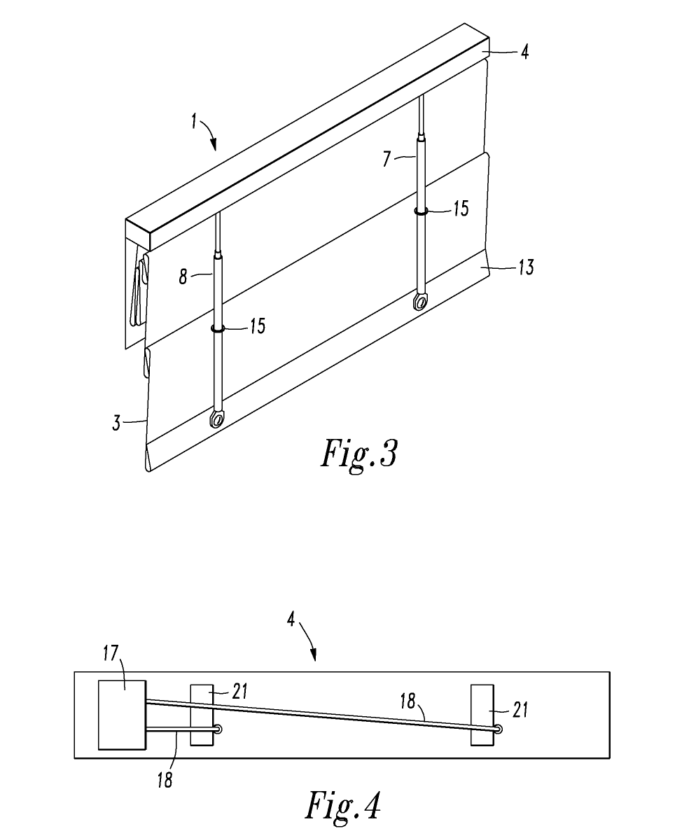

Referring to FIGS. 1-4, a first present preferred embodiment of my window covering 1 includes window covering material 3 that is adjacent to a headrail 4. The window covering material 3 has an upper portion 11 and a lower portion 13. The window covering material 3 is moveable from an extended position, as may be appreciated from FIGS. 1 and 2, to a retracted position, as may be appreciated from FIG. 3. A valance 6 is attached to the headrail 4. The window covering 1 includes a first telescoping tube 7 and a second telescoping tube 8.

Each telescoping tube extends from the headrail 4 to the lower portion 13 of the window covering material. Each telescoping tube is configured to extend when the window covering material 3 is in an extended position and be retracted when the window covering material is in the retracted position. Each telescoping tube 7, 8 includes two or more tube portions of progressively smaller or larger diameter such that each smaller tube fits and moves within the tube having the next larger diameter. The telescoping tubes or telescoping tube portions may be generally cylindrical or generally polygonal in shape.

The window covering material 3 may be composed of a film, interconnected fabric segments, a panel of fabric, woven wood, woven grass, bamboo, non-woven material or woven material. The window covering material could also be pleated material, such as cellular material or material for use in a pleated shade.

The telescoping tubes 7 and 8 are preferably composed of metal or plastic. Most preferably, the telescoping tubes are composed of a material that does not detract from the aesthetic effect of the window covering. For example, the telescoping tubes may be composed of a transparent plastic or a relatively transparent material. As another example, the telescoping tubes may be composed of an opaque material such as a material that is colored similar to the color of the window covering material.

Because the telescoping tubes are rigid and fixed at opposite ends of the headrail and bottom rail or lower portion of the window covering material, the telescoping tubes cannot be wrapped around a child. Similarly, because the portions of the lift cords that extend to the bottom of the window covering are within the telescoping tubes, a child cannot become entangled in the lift cords.

As may be appreciated from FIG. 4, a lift mechanism that controls the raising and lowering of the window covering material 3 is provided in the headrail 4 of the window covering. The lift mechanism may include one or more spring motors 17 that are attached to a plurality of lift cords 18. The lift cords may be composed of tape, thread, or other materials. The lift cords 18 extend from the spring motor 17 and pass through holes in the headrail 4. Each lift cord may extend through a respective hole in the headrail 4 and pass into a telescoping tube to the bottom portion 13 of the window covering material. The end of each lift cord may be attached to the bottom portion 13 of the window covering material.

It should be understood that the window covering material may be attached to the telescoping tubes at various different locations along the length or height of the tubes. For instance, clips or rings 15 may encircle each telescoping tube and also be attached to the window covering material at certain locations. The rings 15 or clips may retain portions of the window covering material relatively close to the telescoping tubes to prevent large gaps from being formed between one or more of the telescoping tubes and the window covering material. The prevention of such large gaps can help prevent children from becoming stuck between the telescoping tubes and the window covering material.

Such rings 15, clips, or other fasteners may also help provide a particular aesthetic effect to the window covering material. For instance, the rings 15 may be included in a Roman shade to help cause horizontal folds to form in the material when the shade material is raised.

It is also contemplated that some embodiments of my window covering may include generally U-shaped telescoping tubes or generally J-shaped telescoping tubes that are configured for use in roll-up shades. One end of each telescoping tube would be attached to the headrail on the front face of the blind and the other end would be attached to the window covering material adjacent to the headrail on the rear face of the blind. For instance, the opposite end could be attached to the headrail on the rear face of the blind.

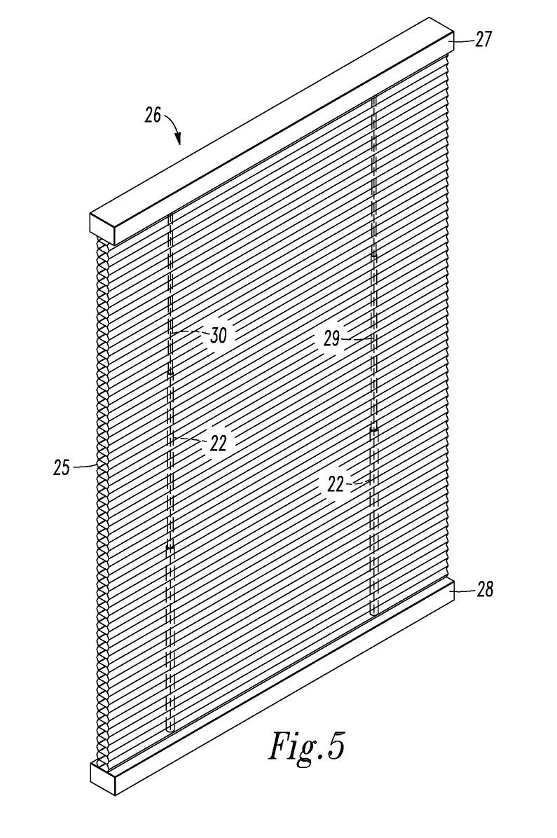

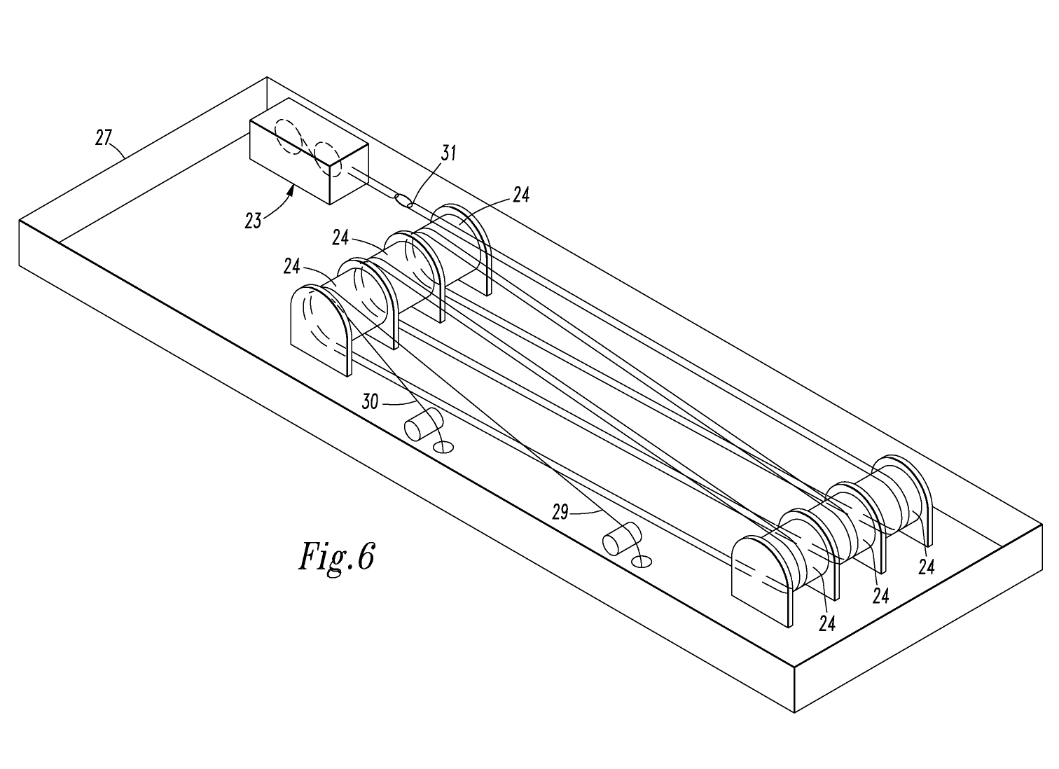

In some embodiments of my window covering, the lift mechanism may include only one lift cord, as may be seen in the embodiment of my window covering shown in FIGS. 5 and 6. The shade 26 includes a headrail 27 and a bottom rail 28. Window covering material 25 and telescoping tubes are attached between the headrail 27 and bottom rail 28. A lift mechanism is positioned within the headrail 27. The lift mechanism includes a spring motor 23 that is attached to a lift cord 32. A middle portion 31 of the lift cord is attached to the spring motor 23. End portions 29 and 30 of the lift cord extend from the middle portion 31 over a number of pulleys 24 located in the headrail. Each end portion 29 and 30 of the lift cord passes through a respective hole in the headrail and into a respective telescoping tube 22. Each end portion 29 and 30 terminates at the bottom rail 28 and is attached to the bottom rail. The end portions 29 and 30 are enclosed within the headrail 27, the telescoping tubes 22, and the bottom rail 28.

It should be appreciated that the lift cords are at least partially enclosed by the telescoping tubes. Preferably, no portion of a lift cord is accessible outside of the headrail 4 or a telescoping tube. Such a design prevents a child from grasping or playing with a lift cord and, therefore, should also prevent a child from becoming entangled within any of the lift cords.

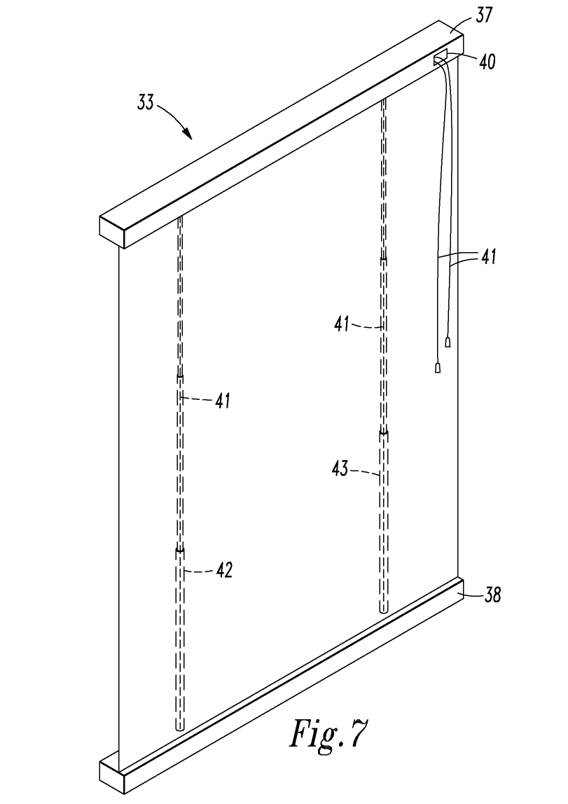

It is also contemplated that embodiments of my window covering may utilize other lift mechanisms, such as lift mechanisms that include a cord lock. As may be seen in FIG. 7, a blind 33 includes window covering material 35 that is positioned between a headrail 37 and a bottom rail 38. The window covering material 35 is moveable such that the window covering material extends when the blind is lowered and retracts when the blind is raised. The telescoping tubes 42 and 43, which are shown in dotted line, are configured to extend when the window covering material extends and retract when the window covering material retracts. One end of each tube is attached to the headrail 37 and the other end of each tube is attached to the bottom rail 38.

A cord lock 40 is positioned in the headrail. Lift cords 41 pass through the cord lock 40 and into the telescoping tubes 42 and 43 of the blind 33. A user may pull the lift cords out of the cord lock 40 to raise the blind or manipulate the portion of the lift cords that extend out of the cord lock and the headrail to lower the blind.

It is also contemplated that embodiments of my window covering may not require any lift cords, cord locks or spring motors. For instance, embodiments of my window covering can include telescoping tubes that are configured to maintain the position of the window covering material. For instance, the telescoping tube portions may be configured to create sufficient friction during movement or adjustment of the tube portions such that the tube portions can maintain a position of the window covering material unless an additional force acts on the window covering material. A user may provide such an additional force to lift or lower the window covering material. For instance, if a user wishes to lower the window covering material, the user may manually pull the window covering material or bottom rail of the window covering downward such that the exerted force overcomes the friction between the tube portions and causes the telescoping tube to extend to lower the window covering material. If a user wishes to raise the window covering material, the user may apply an upward force to the bottom rail of window covering material such that the exerted force overcomes the friction between the tube portions and causes the telescoping tube to retract to raise the window covering material.

Wider blinds often have three or more lift cords extending from the headrail to the lower portion of the window covering material or to a bottom rail. Should a blind be of a size that a child could only reach and become entangled in the outermost lift cords, one may choose to use telescoping tubes for only the outermost lift cord runs. The innermost lift cords of such a blind could be attached n a conventional manner without the use of telescoping tubes.

It should be appreciated that other variations of the present preferred embodiments discussed above may be made. For example, the number of lift cords required for any particular window covering can vary according to the size and weight of the shade material. The number of telescoping tubes utilized in a blind or shade may also vary according to the weight of the shade material and other design considerations. As yet another example, embodiments of my window covering may include top down/bottom up shades.

While certain present preferred embodiments of my window covering and methods of making and using the same have been shown and described above, it is to be distinctly understood that the invention is not limited thereto but may be otherwise variously embodied and practiced within the scope of the following claims.

I claim:

1. A window covering comprising:
a first rail;
window covering material positioned adjacent to the first rail, the window covering material moveable from a retracted position to an extended position, the window covering material having an upper portion and a lower portion; and
at least one telescoping tube extending from the first rail to a position adjacent to the lower portion of the window covering material, opposite ends of the at least one telescoping tube being attached to the first rail and the window covering material.

2. The window covering of claim 1 wherein the at least one telescoping tube has a generally cylindrical or generally polygonal shape.

3. The window covering of claim 1 further comprising a second rail attached to the window covering material adjacent to the lower portion of the window covering material and wherein each telescoping tube has a top portion attached to the first rail and a bottom portion attached to the second rail.

4. The window covering of claim 1 further comprising a lift mechanism attached to the first rail and a plurality of lift cords attached to the lift mechanism, the lift cords extending from the first rail to the window covering material, each lift cord extending through a respective telescoping tube.

5. The window covering of claim 4 further comprising a second rail attached to the window covering material adjacent to the lower portion of the window covering material and wherein each telescoping tube has a top portion attached to the first rail and a bottom portion attached to the second rail, wherein the first rail has a plurality of holes sized and configured to permit a lift cord to pass, each lift cord passing through a respective hole to the second rail.

6. The window covering of claim 4 wherein the lift mechanism is comprised of a cord lock.

7. The window covering of claim 4 wherein the lift mechanism is comprised of a spring motor.

8. The window covering of claim 1 further comprising a lift mechanism attached to the first rail and a lift cord attached to the lift mechanism, the lift cord extending from the first rail to the window covering material and wherein the at least one telescoping tube is comprised of a first telescoping tube and a second telescoping tube, each telescoping tube being configured to extend when the window covering material is moved to the extended position and each telescoping tube being configured to retract when the window covering material is moved to the retracted position, a first portion of the lift cord extending through the first telescoping tube and a second portion of the lift cord extending through the second telescoping tube.

9. The window covering of claim 8 further comprising a second rail attached to the first telescoping tube and the second telescoping tube, the first portion of the lift cord and the second portion of the lift cord extending to the second rail.

10. The window covering of claim 9 wherein lift cord has a first end and a second end opposite the first end, the first portion of the lift cord being the first end of the lift cord and the second portion of the lift cord being the second end of the lift cord.

11. The window covering of claim 1 wherein the window covering material is woven wood, fabric, woven grass, bamboo, or a film.

12. The window covering of claim 1 wherein the at least one telescoping tube is positioned within the window covering material.

13. The window covering of claim 1 wherein the window covering material at least partially encloses the at least one telescoping tube.

14. The window covering of claim 1 wherein the first rail is a headrail or a bottom rail.

15. The window covering of claim 1 wherein the at least one telescoping tube is composed of metal or plastic.

16. The window covering of claim 1 wherein the at least one telescoping tube is comprised of a plurality of telescoping tube portions, each tube portion being moveable relative to at least one other tube portion.

17. A window covering comprising:
a headrail;
window covering material positioned adjacent to the headrail, the window covering material moveable from a retracted position to an extended position, the window covering material having an upper portion and a lower portion;
a bottom rail;
a plurality of telescoping tubes, each telescoping tube having a first end attached to the headrail and a second end opposite the first end attached to the bottom rail, each telescoping tube configured to extend when the window covering material is moved to the extended position and each telescoping tube being configured to retract when the window covering material is moved to the retracted position.

18. The window covering of claim 17 further comprising a lift mechanism attached to the headrail and a plurality of lift cords attached to the lift mechanism, the lift cords extending from the first rail to the bottom rail, a portion of each lift cord extending through a respective telescoping tube.

19. The window covering of claim 17 further comprising a spring motor attached to the headrail and a lift cord attached to the spring motor, the lift cord having a first portion attached to the spring motor, and a plurality of other portions extending from the headrail to the bottom rail, each other portion being at least partially enclosed within a respective telescoping tube.

20. The window covering of claim 17 wherein the telescoping tubes are composed of a substantially transparent material or an opaque material.
